(19) United States
(12) Patent Application Publication
(10) Pub. No.: US 2013/0262797 A1
(43) Pub. Date: Oct. 3, 2013

(54) SYSTEM CONTROLLER, INFORMATION PROCESSING APPARATUS, AND METHOD OF CONTROLLING SYSTEM CONTROLLER

(71) Applicant: FUJITSU LIMITED, Kawasaki-shi (JP)

(72) Inventor: Satoshi NAKAGAWA, Fuchu (JP)

(21) Appl. No.: 13/736,119

(22) Filed: Jan. 8, 2013

(30) Foreign Application Priority Data
Mar. 29, 2012 (JP) 2012-075889

(51) Int. Cl. G06F 12/00

(52) U.S. Cl. CPC G06F 12/00
USPC 711/156

(57) ABSTRACT

A system controller connected to a plurality of processors includes a request store that stores a request from a first processor of the plurality of processors; a return store that stores a return to a second processor of the plurality of processors, the return corresponding to the request from the first processor; and a priority unit that outputs the return prior to the request, if a return has been stored in the return store when a request is stored in the request store, and outputs the request prior to the return, if no return has been stored in the return store when the request is stored in the request store.

### CROSS-REFERENCE TO RELATED APPLICATION

This application is based upon and claims the benefit of priority of the prior Japanese Patent Application No. 2012-075889, filed on Mar. 29, 2012, the entire contents of which are incorporated herein by reference.

### FIELD

The present disclosure relates to a system controller, an information processing apparatus, and a method of controlling a system controller.

### BACKGROUND

In memory-shared multi-processor systems, such as symmetrical multi processors (SMPs), data is exchanged between a processor and a memory, and among the multiple processors. In such systems, each processor independently updates data. In order to ensure the consistency of data, a system controller (SC) monitors caches in the processors and controls the order of data modifications made by the processors.

A processor handles data in a unit of packet, for example. There are two types of packets: request packets initiated by the processor (e.g., for memory fetches) and return packets issued in response to requests from other processors (e.g., for memory store, data transfer among the processors).

Generally, a system controller includes a priority circuit that receives request packets from processors, and determines their priorities and selects a request from these requests (this process is referred to as “prioritizing”). The priority circuit priotizes requests output from the processors and sends the selected request to a snoop pipeline for checking statuses of the caches in the processors. When the snoop produces a cache miss, the system controller accesses to the main memory. Otherwise, upon a cache hit, the system controller issues an order to the processor that caches the requested data.

Some system architectures impose a restriction that a request packet is not allowed getting ahead of a return packet in order to ensure coherency of data in caches. Such a restriction is embodied by a priority circuit that is included in a system controller and selects a packet to be sent, by selecting a return packet preferentially to a request packet any time.

Here, an example of hardware configuration of an information processing system 200 as an information processing apparatus where such a conventional system controller 102 is employed will be described.

FIG. 6 is a diagram schematically illustrating a hardware configuration of an information processing system 200 where a conventional system controller 102 is employed.

The information processing system 200 includes one or more central processing units (CPUs) 101-1 to 101-n (n is an integer of one or greater), a system controller 102, an input/output unit (IO) 103, an memory access controller (MAC) 104, and one or more dynamic random access memories (DRAMs) 105-1 to 105-m (m is an integer of one or greater).

The CPUs 101-1 to 101-n are processors that load programs (not illustrated) from the DRAMs 105-1 to 105-m and an operation system (OS) from a storage (not illustrated), for executing various types of processing.

The system controller 102 is connected to the CPUs 101-1 to 101-n, the IO 103, and the MAC 104 via a bus, and is mounted on a single system board (SB). The system controller 102 further includes a further bus for connecting to a different SB (not illustrated).

The IO 103 is an input/output interface used for connecting the information processing system 200 to external system(s), and is a network interface board or a SCSI (Small Computer Systems Interface) card, for example.

The MAC 104 is a controller that controls accesses to the DRAMs 105-1 to 105-m with the system controller 102.

The DRAMs 105-1 to 105-m are storages that store various types of data and programs, upon the CPUs 1-1 to 1-n executing computations and controls.

Note that one of the reference symbols 101-1 to 101-n is used hereinafter for referring to a specific CPU while reference symbol 101 is used when reference is made to any of the multiple CPUs.

One of the reference symbols 105-1 to 105-m is used hereinafter when reference is made to one of multiple DRAMs while reference symbol 105 is used when reference is made to any of the DRAMs.

In the information processing system 200 with such a configuration, for example, one of the CPUs 101 issues a request packet to the system controller 102.

The system controller 102 snoops the requested data to check whether or not the data is cashed in a cache (not illustrated) in any of other CPUs 101. If the requested data is cashed in a cache in any of other CPUs 101 (i.e., the data is hit), the system controller 102 issues an order to that CPU 101.

Otherwise, if the requested data is not cashed in a cache in any of other CPUs 101 (i.e., the data does not hit), the system controller 102 sends a memory request to the MAC 104.

In response to receiving a return packet from the CPU 101 to which the order was issued, or the MAC 4 to which the memory request was issued, the system controller 102 forwards that return packet to the CPU 101 which initiated the request packet.

FIG. 7 is a diagram schematically illustrating an exemplary configuration of the system controller 102 in a conventional information processing system 200.

The system controller 102 includes a return queue (RQQ) unit 130, a return queue (RTNQ) unit 140, a priority circuit (PRIO) 112, a request resource used counter (RQ USED-CT) 113, and a return resource used counter (RTN USED-CT) 114.

The request queue unit 130 processes a request queue, and includes a request queue write pointer (WTPT) 106, a request queue read pointer (RDPT) 107, and a request queue 108.

The request queue 108 is a first-in first-out (FIFO) queue with eight entries 108-0 to 108-7, and stores request packets received from the CPU 101 and/or the IO 103.

Note that one of the reference symbols 108-0 to 108-7 is used hereinafter for referring to a specific entry in the request queue while reference symbol 108 is used when reference is made to any of the multiple entries in the request queue or to the request queue as a whole.

The request queue write pointer 106 is a pointer pointing one of the entries 108-0 to 108-7 in the request queue 108 to which a request packet received from the CPU 101 or the IO 103 is to be written.

The request queue read pointer 107 is a pointer pointing one of the entries 108-0 to 108-7 in the request queue 108, from which a request packet is to be read.

The return queue unit 140 processes a return queue, and includes a return queue write pointer 109, a return queue read pointer 110, and a return queue 111.

The return queue 111 is an FIFO queue with eight entries 111-0 to 111-7, and stores return packets received from the CPU 101, the IO 103, and/or MAC 104.

Note that one of the reference symbols 111-0 to 111-7 is used hereinafter for referring to a specific entry in the return queue while reference symbol 111 is used when reference is made to any of the multiple entries in the return queue or to the return queue as a whole.

The return queue write pointer 109 is a pointer pointing one of the entries 111-0 to 111-7 in the return queue 111 to which a return packet received from the CPU 101, the IO 103, or the MAC 104, is to be written.

The return queue read pointer 110 is a pointer pointing one of the entries 111-0 to 111-7 in the return queue 111 from which a return packet is to be read.

The priority circuit 112 is a circuit that selects a packet to be transmitted from the system controller 102, between the request queue unit 130 and the return queue unit 140. In other words, the priority circuit 112 is a control circuit that selects either of a request packet and a return packet. The priority circuit 112 receives prioritization request signals (not illustrated) from at least one of the request queue unit 130 and the return queue unit 140, and always selects the return queue unit 140, if the prioritization request signals conflict. Hence, even when return packet destination resources are busy and hence no more return packet can be sent, a request packet is prevented from being transmitted.

In the information processing system 200 that unconditionally selects return packets as described above, when a large amount of return packets are sent, request packets are not selected by the priority circuit 112 and remain queued in the return queue 108 for a long time.

At that time, a circuit for processing the request packets does not operate, resulting in a degrading of the processing performance of the information processing system 200.

One solution to this issue is to select a request packet preferentially to a return packet, if that request packet is forced to wait for certain time duration.

This technique, however, cannot ensure that the correct order of return packets and request packets are maintained.

There are several solution to maintain the order, and one solution is the configuration described in Japanese Patent Laid-Open Hei 8-249295, for example.

The configuration described in Japanese Patent Laid-Open Hei 8-249295, however, has an increased bit count of a flip-flop (FF) of N(1+log₂N), where N indicates the number of queue entries, for example. The bit count of the FF, N(1+log₂N), is 32 bits or 448 bits, when N is 8 or 64, respectively. The size of the circuit is increased more rapidly than the increase in the bit count, when the bit count of the flip-flop is increased. Further, comparison circuits are used in a large number equal to the number of queue entries, which complicates the circuit design.

Accordingly, it is desired to prevent degrading of the performance in a system controller adapting a technique of transmitting a return packet preferentially to a request packet, with a smaller circuit.

### SUMMARY

In one aspect, the present disclosure is directed to providing a technique which can prevent degrading of the performance in a system controller adapting a technique of transmitting a return packet preferentially to a request packet.

A system controller, the system controller being connected to a plurality of processors, the system controller includes: a request store that stores a request from a first processor of the plurality of processors; a return store that stores a return to a second processor of the plurality of processors, the return corresponding to the request from the first processor; and a priority unit that outputs the return prior to the request, if a return has been stored in the return store when a request is stored in the request store, and outputs the request prior to the return, if no return has been stored in the return store when the request is stored in the request store.

A information processing apparatus including: a plurality of processors; and a system controller, the system controller includes: a request store that stores a request from a first processor of the plurality of processors; a return store that stores a return to a second processor of the plurality of processors, the return corresponding to the request from the first processor; and a priority unit that outputs the return prior to the request, if a return has been stored in the return store when a request is stored in the request store, and outputs the request prior to the return, if no return has been stored in the return store when the request is stored in the request store.

A method of controlling a system controller, the system controller being connected to a plurality of processors, the system controller including a request store that stores a request from a first processor of the plurality of processors, and a return store that stores a return to a second processor of the plurality of processors, the return corresponding to the request from the first processor, the method includes: outputting, by a priority unit, the return prior to the request, if a return has been stored in the return store when a request is stored in the request store; and outputting, by the priority unit, the request prior to the return, if no return has been stored in the return store when the request is stored in the request store.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram schematically illustrating an example of a hardware configuration of an information processing system where a system controller as an example of the first embodiment is employed;

FIG. 2 is a diagram schematically illustrating an exemplary configuration of the system controller as an example of the first embodiment;

FIG. 3 is a time chart illustrating processing in the system controller as an example of the first embodiment;

FIG. 4 is a diagram schematically illustrating an example of a system controller as an example of a second embodiment;

FIG. 5 is a time chart illustrating processing in the system controller as an example of the second embodiment;

FIG. 6 is a diagram schematically illustrating an example of a hardware configuration of a conventional information processing system; and

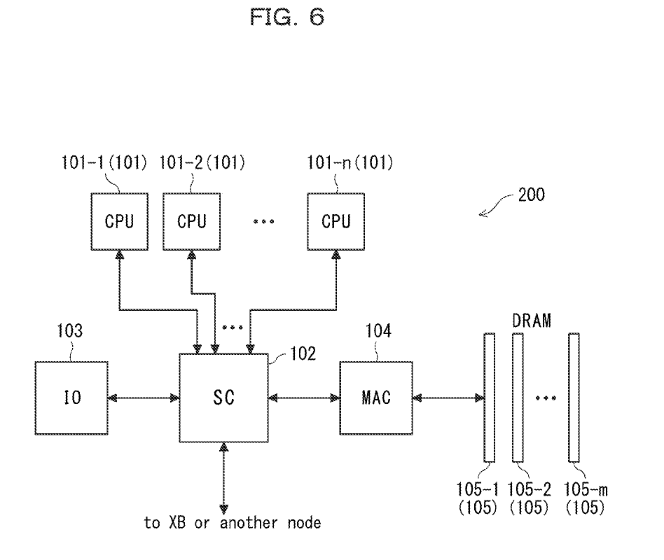

FIG. 7 is a diagram schematically illustrating an exemplary configuration of a system controller in a conventional information processing system.

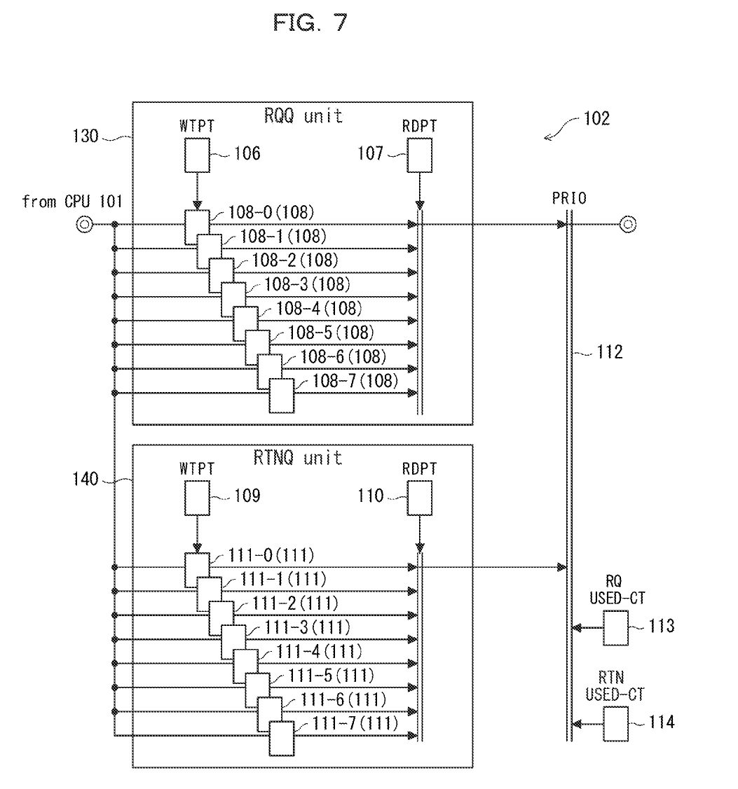

### DESCRIPTION OF EMBODIMENT(S)

Hereinafter, embodiments of the present disclosure will be described with reference to the drawings.

### (1) First Embodiment

Firstly, an example of a hardware configuration of an information processing system 20 where a system controller 2 as an example of a first embodiment will be described.

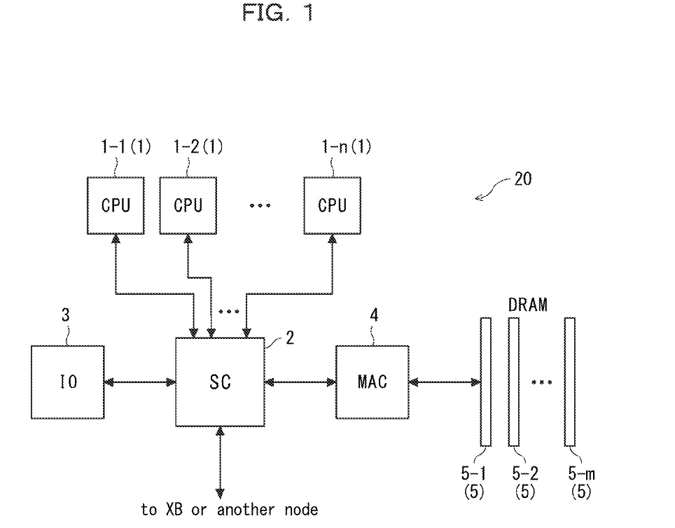

FIG. 1 is a diagram schematically illustrating an example of a hardware configuration of the information processing system 20 where a system controller 2 as an example of the first embodiment is employed.

The information processing system 20 includes one or more CPUs 1-1 to 1-n (n is an integer of one or greater), a system controller 2, an IO 3, an MAC 4, and one or more DRAMs 5-1 to 5-m (m is an integer of one or greater).

The CPUs 1-1 to 1-n are processors that load programs (not illustrated) from the DRAMs 5-1 to 5-m and an OS from a storage (not illustrated), for executing various types of processing.

The system controller 2 is connected to the CPUs 1-1 to 1-n, the IO 3, and the MAC 4 via a bus, and is mounted on a single system board (SB). The system controller 2 further includes a further bus for connecting to a different SB (not illustrated).

The IO 3 is an interface used for connecting the information processing system 20 to external system(s), and is a network interface board or a SCSI (Small Computer Systems Interface) card, for example.

The MAC 4 is a controller that controls accesses to the DRAMs 5-1 to 5-m with the system controller 2.

The DRAMs 5-1 to 5-m are storages that store various types of data and programs, upon the CPUs 1-1 to 1-n executing computations and controls.

Note that one of the reference symbols 1-1 to 1-n is used hereinafter for referring to a specific CPU while reference symbol 1 is used when reference is made to any of the multiple CPUs.

One of the reference symbols 5-1 to 5-m is used hereinafter when reference is made to one of multiple DRAMs while reference symbol 5 is used when reference is made to any of the DRAMs.

In the information processing system 20 with such a configuration, for example, one of the CPUs 1 issues a request packet to the system controller 2.

The system controller 2 snoops the requested data to check whether or not the data is cashed in a cache (not illustrated) of another CPU 1. If the requested data is cashed in a cache of another CPU 1 (i.e., the data is hit), the system controller 2 issues an order to that CPU 1.

Otherwise, if the requested data is not cashed in a cache of another CPU 1 (i.e., the data does not hit), the system controller 2 sends a memory request to the MAC 4.

In response to receiving a return packet from the CPU 1 to which the order was issued, or the MAC 4 to which the memory request was issued, the system controller 2 forwards that return packet to the CPU 1 which initiated the request packet.

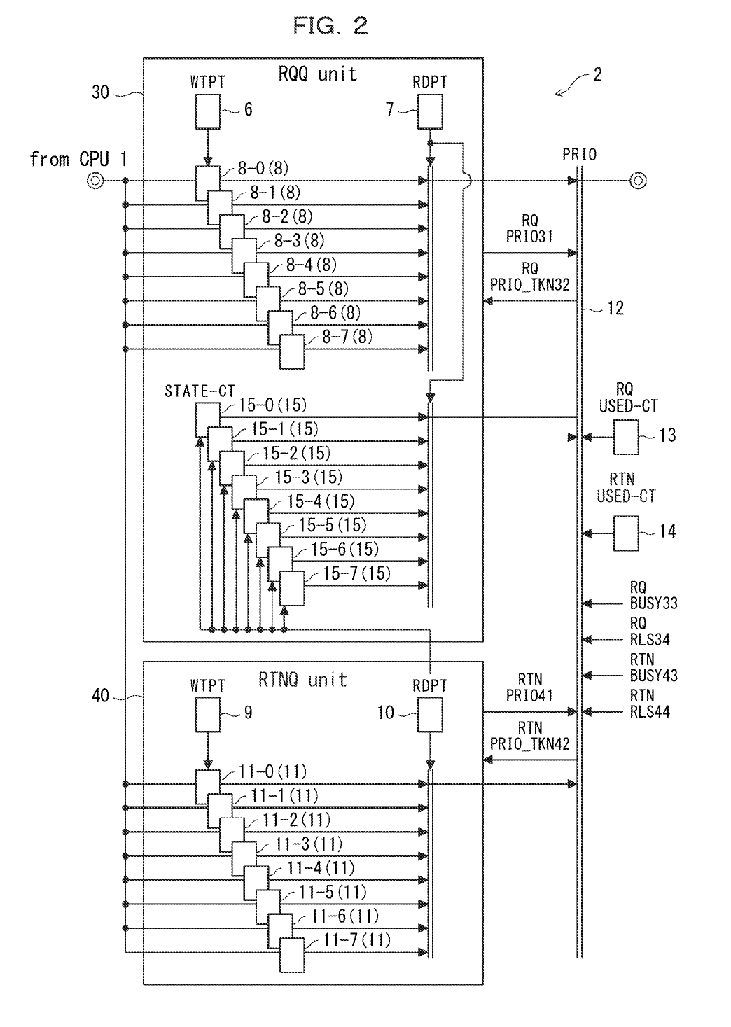

For the above operation, the system controller 2 includes multiple FIFO queues that receive and store request packets or return packets, as depicted in FIG. 2.

FIG. 2 is a diagram schematically illustrating an exemplary configuration of the system controller 2 as an example of a first embodiment.

The system controller 2 includes a request queue (RQQ) unit 30, a request queue (RTNQ) unit 40, a priority circuit (priority unit, PRIO) 12, a request resource used counter (RQ USED-CT) 13, and a return resource used counter (RTN USED-CT) 14.

The request queue unit 30 processes a request queue, and includes a request queue write pointer (WTPT) 6, a request queue read pointer (RDPT) 7, a request queue 8, and a status counters (STATE-CTs) 15-0 to 15-7.

The request queue 8 is an FIFO queue with eight entries 8-0 to 8-7, and stores request packets received from the CPU 1 and/or the IO 3.

Note that one of the reference symbols 8-0 to 8-7 is used hereinafter for referring to a specific entry in the request queue while reference symbol 8 is used when reference is made to any of the multiple entries in the request queue or to the request queue as a whole.

The write pointer 6 is a pointer pointing one of the entries 8-0 to 8-7 in the request queue 8 to which a request packet received from the CPU 1 and/or the IO 3, is to be written.

The read pointer 7 is a pointer pointing one of the entries 8-0 to 8-7 in the request queue 8, from which a request packet is to be read.

The status counters 15-0 to 15-7 are 2-bit wide counters corresponding to the respective entries 8-0 to 8-7 in the request queue 8.

The status counters 15-0 to 15-7 are connected to the return queue read pointer 10 which will be described later.

The operation of the status counters 15-0 to 15-7 will be described later.

If the value of the request queue write pointer 6 matches the value of the request queue read pointer 7, the request queue 8 does not contain any packet and the request queue unit 30 does not participate in priotization (does not sends a prioritization request signal (RQ PRIO) 31).

In contrast, if the value of the request queue write pointer 6 does not match the value of the request queue read pointer 7 and if any request packet destination resource (not illustrated) is not busy, the request queue unit 30 sends an RQ PRIO 31 to the priority circuit 12.

The return queue unit 40 processes a return queue, and includes a return queue write pointer 9, a return queue read pointer 10, and a return queue 11.

The return queue 11 is an FIFO queue with eight entries 11-0 to 11-7, and stores return packets received from the CPU 1, the IO 3, and/or MAC 4.

Note that one of the reference symbols 11-0 to 11-7 is used hereinafter for referring to a specific entry in the return queue while reference symbol 11 is used when reference is made to any of the multiple entries in the return queue or to the return queue as a whole.

The return queue write pointer 9 is a pointer pointing one of the entries 11-0 to 11-7 in the return queue 11 to which a return packet received from the CPU 1, the IO 3, or the MAC 4, is to be written.

The return queue read pointer 10 is a pointer pointing one of the entries 11-0 to 11-7 in the return queue 11 from which a return packet is to be read.

Note that both of the request queue 8 and the return queue 11 are illustrated to include eight entries, they may have more or less entries.

If the value of the return queue write pointer 9 matches the value of the return queue read pointer 10, the return queue 11 does not contain any packet and the return queue unit 40 does not participate in priotization (does not sends a prioritization request signal (RTN PRIO) 41).

In contrast, if the value of the return queue write pointer 9 does not match the value of the return queue read pointer 10, the return queue unit 40 sends an RTN PRIO 41 to the priority circuit 12.

The request resource used counter 13 is a request resource used counter indicating the number of request packet destination resources. The request resource used counter 13 is incremented by one every time a request packet destination resource is consumed, while is decremented by one every time a request packet destination resource is released.

The return resource used counter 14 is a return resource used counter indicating the number of return packet destination resources. The return resource used counter 14 is incremented by one every time a return packet destination resource is consumed, while is decremented by one every time a return packet destination resource is released.

The priority circuit 12 is a circuit that selects a packet to be transmitted from the system controller 2, between the request queue unit 30 and the return queue unit 40. In other words, the priority circuit 12 is a control circuit that selects either of a request packet and a return packet. The priority circuit 12 receives prioritization request signals (RQ PRIO 31 and RTN PRIO 41) from at least one of the request queue unit 30 and the return queue unit 40, and selects the return queue unit 40 except for the following exception, if the prioritization request signals conflict. Hence, even when return packet destination resources are busy and hence no more return packet can be sent, a request packet is prevented from being transmitted.

Accordingly, when one or more packets are stored in the return queue 11, any packets in the request queue 8 are prevented from being selected. By executing such a control, the priority circuit 12 prevents a request packet from being transmitted prior to a return packet (prevents the request packet from getting ahead of the return packet).

The request queue unit 30 further includes status counters 15-0 to 15-7 that are 2-bit wide counters corresponding to the respective the entries 8-0 to 8-7 in the request queue 8.

The status counters 15-0, 15-1, 15-2, and 15-3 respectively correspond to the entries 8-0, 8-1, 8-2, and 8-3 in the request queue 8. The status counters 15-4, 15-5, 15-6, and 15-7 respectively correspond to the entries 8-4, 8-5, 8-6, and 8-7 in the request queue 8.

Note that one of the reference symbols 15-0 to 15-7 is used hereinafter for referring to a specific status counter while reference symbol 15 is used when reference is made to any of the multiple status counters or to the status counters as a whole.

In the status counter 15, while a request packet is stored in corresponding one of the entries 8-0 to 8-7 in the request queue 8, the one of the status counter 15-0 to 15-7 corresponding to that entry 8-0 to 8-7 is counted up by one, in response to the return queue read pointer 10 being incremented from “0” to “1”.

For example, when the return queue read pointer 10 is incremented from “0” to “1” while a request packet is stored in the entry 8-0 in the request queue 8, the status counter 15-0 is counted up by one.

In other words, an increment of the value of one of the status counters 15-0 to 15-7 to “2” indicates that the return queue read pointer 10 has circled a single lap or more after a request packet was stored in the corresponding entry 8-0 to 8-7 in the request queue 8.

That is, it is assumed at the time when the request packet is queued in the request queue 8 that all packets stored in the return queue 11 have been transmitted and hence a request packet does not get ahead of the return packets.

Accordingly, the priority circuit 12 selects a request packet preferentially to a return packet if the status counter 15 of the entry in the request queue 8 pointed by the return queue read pointer 10 has a value “2”.

When the return queue 11 is empty, a value “2” is set to all of the status counters 15 corresponding to the entries in the request queue 8 having a packet stored therein.

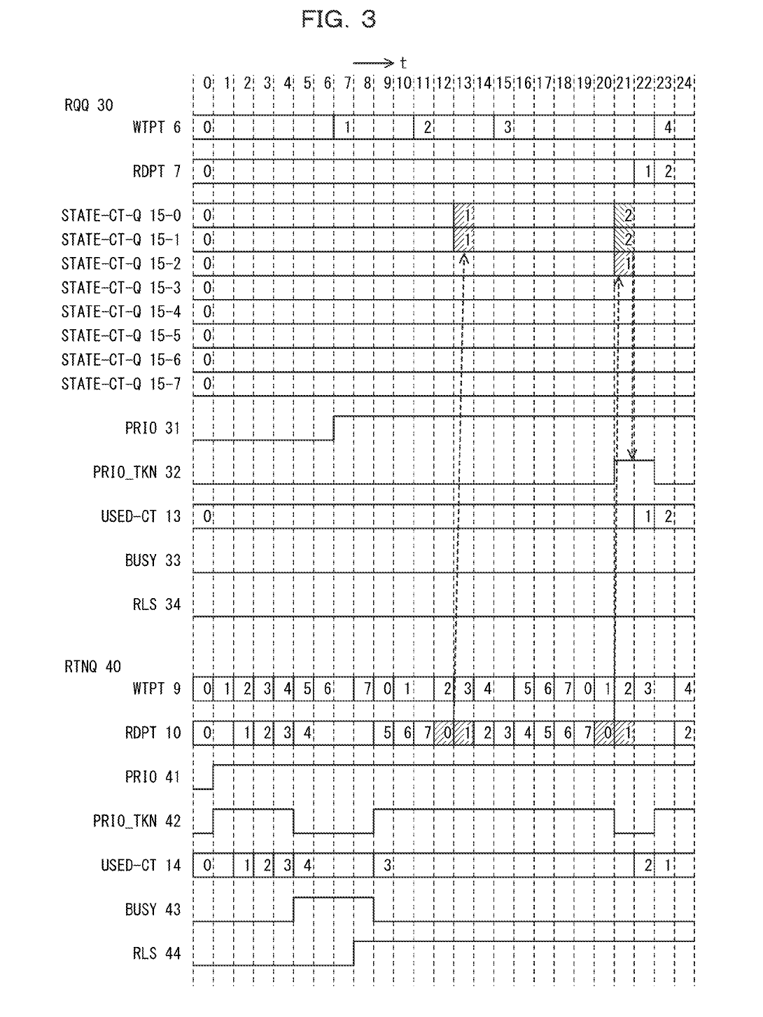

A time chart for that series of operations is depicted in FIG. 3.

FIG. 3 is a time chart illustrating processing in the system controller 2 as an example of the first embodiment.

In FIG. 3, the horizontal line indicates time (cycle), and FIG. 3 illustrates the status of the signals and values of the counters in each cycle.

The “RQQ” in the upper half of FIG. 3 indicates the status of the signals and values of the counters related to the request queue unit 30.

Specifically, the “WTPT 6” and “RDPT 7” indicate the values of the request queue write pointer 6 and the request queue read pointer 7 in FIG. 2, respectively. The “STATE-CT-Q15-0” to “STATE-CT-Q15-7” indicate the values of the status counters 15-0 to 15-7, respectively. The RQ PRIO 31 indicates a prioritization request signal that is sent by the request queue unit 30 to the priority circuit 12 for obtaining a packet sending right for sending a request packet from the request queue 8 outside the system controller 2. The RQ PRIO 31 is enabled when a prioritization request signal is issued from the request queue unit 30 to the priority circuit 12. The PRIO_TKN 32 is a selection signal that is enabled when the priority circuit 12 selects the request queue 8 in response to the prioritization request signal from the request queue 8, whereas it is disabled when the priority circuit 12 selects the return queue 11. The USED-CT 13 indicates the value of the request resource used counter 13. The BUSY 33 is a busy signal for request packet destination resources, and is enabled when all request packet destination resources are used and become busy. The RLS 34 is a release notification signal (RLS) of a request packet destination resource, and is enabled when a request packet destination resource is released.

The “RTNQ” in the bottom half of FIG. 3 indicates the status of the signals and values of the counters related to the return queue unit 40.

For the sake of illustration, there are four return packet destination resources (not illustrated) in this example.

Specifically, the “WTPT 9” and “RDPT 10” indicate the values of the return queue write pointer 9 and the return queue read pointer 10 in FIG. 2, respectively. The RTN PRIO 41 indicates a prioritization request signal that is sent by the return queue unit 40 to the priority circuit 12 for obtaining a packet sending right for sending a return packet from the return queue 11 outside the system controller 2. The RTN PRIO 41 is enabled when a prioritization request signal is issued from the return queue unit 40 to the priority circuit 12. The PRIO_TKN 42 is a selection signal that is enabled when the priority circuit 12 selects the return queue 11 in response to the prioritization request signal from the return queue 11, whereas it is disabled when the priority circuit 12 selects the request queue 8. The USED-CT 14 indicates the value of the return resource used counter 14. The BUSY 43 is a busy signal for return packet destination resources, and is enabled when all return packet destination resources are used and become busy. The RLS 44 is a release notification signal (RLS) of a return packet destination resource, and is enabled when a return packet destination resource is released.

In FIG. 3, at Cycles t1 to t7, return packets are sequentially sent to the system controller 2, and the return queue write pointer 9 (WTPT 9) is incremented.

In response, at Cycle t1, the return queue unit 40 enables the prioritization request signal 41 (RTN PRIO 41) for obtaining right to send a packet from the return queue 11. The priority circuit 12 selects the return queue 11, and enables the selection signal 42 (PRIO_TKN 42).

From Cycle t1 to t4, since the return queue unit 40 obtains the packet sending right, the return queue unit 40 increments the return queue read pointer 10 (RDPT 10) every time a return packet is transmitted. At the same time, the resource used counter 14 (USED-CT 14) that counts the number of used return packet destination resources, is also incremented.

As described above, there are four return packet destination resources. Hence, the value of the resource used counter 14 reaches “4” at Cycle t5, no more return packet can be sent. Accordingly, at Cycle t5, the busy signal 43 (BUSY 43) for the return packet destination resources is enabled.

At Cycle t8, when one return packet destination resource is released, the return packet destination resource release signal 44 (RLS 44) is enabled and the busy signal 43 is disabled. Additionally, at Cycle t8, in response to resource release signal 44 (RLS 44) being enabled, the resource used counter 14 is also decremented.

In the meantime, request packets are intermittently sent while the return packets are sent. Every time a request packet is received, the request queue unit 30 increments the request queue write pointer 6 (WTPT 6) (refer to Cycles t7, t11, t15, and t23).

The priority circuit 12 does not select these request packets since return packets with a priority higher than that of the request packets are stored in the return queue 11.

At Cycle t12, the return queue read pointer 10 (RDPT 10) is incremented from “0” to “1”. In response, at Cycle t13, the status counters 15-0 and 15-1 (STATE-CT-Q0 and STATE-CT-Q1) corresponding to the entries 8-0 and 8-1 in the request queue 8 storing packets are incremented.

Similarly at Cycle t20, the return queue read pointer 10 (RDPT 10) is incremented from “0” to “1”. In response, at Cycle t21, the status counters 15-0 to 15-2 (STATE-CT-Q0, STATE-CT-Q1, and STATE-CT-Q2) corresponding to the entries 8-0, 8-1, and 8-3 in the request queue 8 storing packets are incremented.

As a result, at Cycle t21, the values of the status counters 15-0 to 15-7 for the entries 8-0 and 8-1 in the request queue 8 becomes “2”, and the priority circuit 12 selects a request packet preferentially to a return packet. Consequently, a request packet is transmitted, and the request queue read pointer 7 (RDPT 7) is incremented.

As described above, the system controller 2 as an example of the present embodiment can select request packets with an assistance of the priority circuit 12 and transmit them, even when a large volume of return packets are received.

Accordingly, while satisfying the restriction that request packet are not allowed to get ahead of preceding return packets, the request packets that are forced to wait can be selected preferentially. Hence, request processing is interrupted during return processing, which increases the degree of parallel processing, thereby preventing the performance from degrading.

Further, the bit count for an FF employed in a control circuit of the present embodiment is 2N, where N is the number of queue entries. The bit count is 16 or 128 when N is 8 or 64, respectively, and the control circuit can be implemented with a reduced circuit scale as compared to conventional configurations. Further, no comparison circuit is employed in the system controller 2 as an example of the present embodiment, which simplifies the circuit design.

### (2) Second Embodiment

An example of the first embodiment set forth above uses a 2-bit status counter 15 for each entry in the request queue 8. Hence, the bit count for an FF is increased as the request queue 8 has more entries.

Accordingly, a system controller 2′ as an example of the second embodiment has an improved circuit configuration to reduce the bit count of the FF.

The hardware configuration of an information processing system 20 where the system controller 2′ as an example of the second embodiment is employed is similar to that of the first embodiment depicted in FIG. 1, and an illustration and description therefor are omitted.

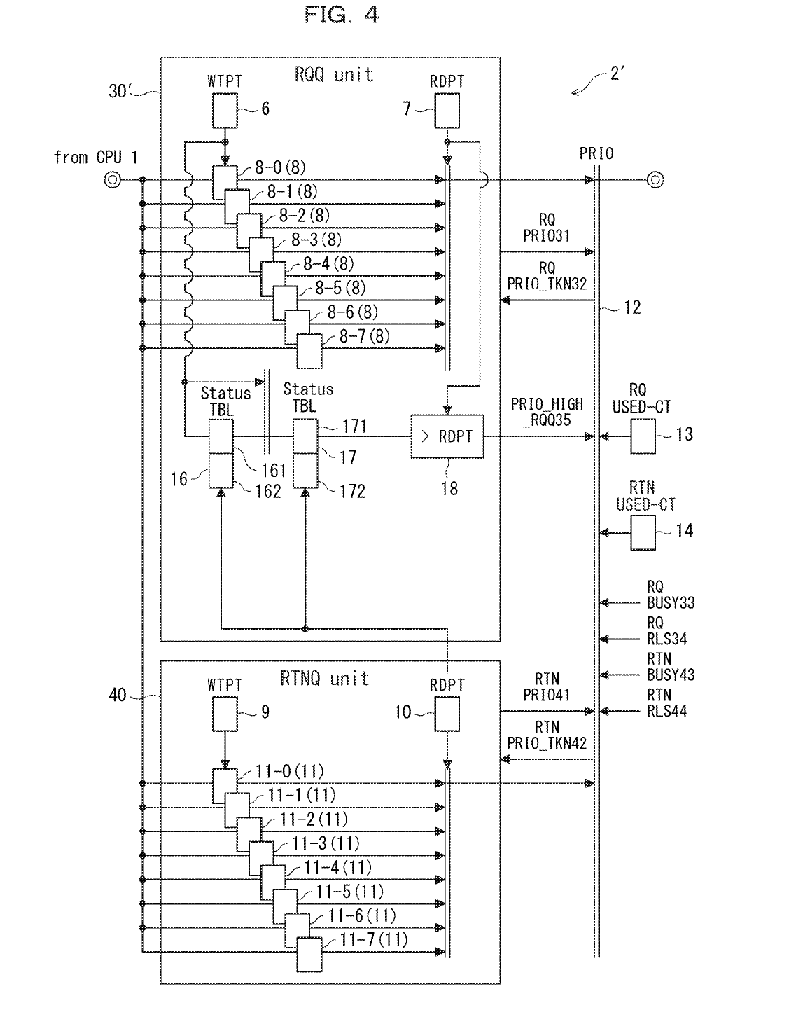

FIG. 4 is a diagram schematically illustrating an exemplary configuration of the system controller 2′ as an example of a second embodiment.

The system controller 2′ includes a request queue unit 30′, a return queue unit 40, a priority circuit 12, a request resource used counter 13, and a return resource used counter 14.

In the system controller 2′ as an example of the second embodiment, the request queue unit 30′ includes status tables (STATUS TBLs) 16 and 17 and a comparison circuit 18, in place of the status counters 15-0 to 15-7.

The other elements in the system controller 2′ are identical to those in the system controller 2 as an example of the first embodiment depicted in FIG. 2, and their description is omitted.

The status table 16 includes a VALID field 161 and a request queue write pointer field 162.

The VALID field 161 is a flag indicating whether the request queue write pointer field 162 (described later) is valid or not. For example, a value “enabled” of the VALID field 161 indicates that the request queue write pointer field 162 is valid.

The request queue write pointer field 162 stores the value of the request queue write pointer 6 at the time when the return queue read pointer 10 was changed from “0” to “1”, as will be described later.

The status table 17 similarly includes a VALID field 171 and a request queue write pointer field 172.

The VALID field 171 is a flag indicating whether the request queue write pointer field 172 (described later) is valid or not. For example, a value “enabled” of the VALID field 171 indicates that the request queue write pointer field 172 is valid.

The request queue write pointer field 172 stores the value of the request queue write pointer 6 at the time the return queue read pointer 10 was changed from “0” to “1” for the first time, when the value of the request queue write pointer 6 at the time the return queue read pointer 10 was changed from “0” to “1” for the second time.

When the return queue read pointer 10 is incremented from “0” to “1”, the request queue unit 30′ sets the value of the request queue write pointer 6 to the request queue write pointer field 162, unless the request queue 8 is not empty (i.e., if a request packet is stored in any of the entries 8-0 to 8-7). In response, the request queue unit 30′, for example, sets the VALID field 161 to “enabled” to indicate that the request queue write pointer field 172 is valid.

Thereafter, when the return queue read pointer 10 is incremented from “0” to “1” once again, the request queue unit 30′ forwards the value of the VALID field 161 to the VALID field 171. Additionally, the request queue unit 30′ forwards the value of the request queue write pointer field 162 to the request queue write pointer field 172.

When the status VALID field 171 is enabled, the priority circuit 12 selects a request packet preferentially to a return packet until the request queue read pointer 7 catches up to the value of the request queue write pointer field 172.

When the request queue read pointer 7 catches up to the value of the request queue write pointer field 172 (i.e. the two values match), the VALID fields 161 and 171 are reset. If the return queue 11 is empty, the request queue unit 30′ sets the value of the request queue write pointer 6 directly to the request queue write pointer field 172, as well as enabling the VALID field 171.

The comparison circuit 18 compares the value of the status table 17 against the values of the request queue write pointer 6 and the request queue read pointer 7. Specifically, when the STATE-TLB-V171 is enabled and WTPT 6 is greater than RDPT 7, a signal PRIO_HIGH_RQQ 35 is enabled, which instructs the priority circuit to select a request packet preferentially to a return packet if RDPT 7<STATE-TLB 172<WTPT 6 stands. Alternatively, when the STATE-TLB-V171 is enabled and WTPT 6 is smaller than RDPT 7, the signal PRIO_HIGH_RQQ 35 is enabled if WTPT 6<STATE-TLB 172 or RDPT 6>STATE-TLB 172 stands.

The system controller 2′ as an example of the second embodiment having such a configuration can execute controls similar to the configuration including the status counters 15-0 to 15-7 corresponding to the entries. Even when the number of entries in the request queue 8 is increased, the bit count of the FF is not substantially increased, since the bit widths of the status tables 16 and 17 increase only with the bit width of the request queue write pointer 6.

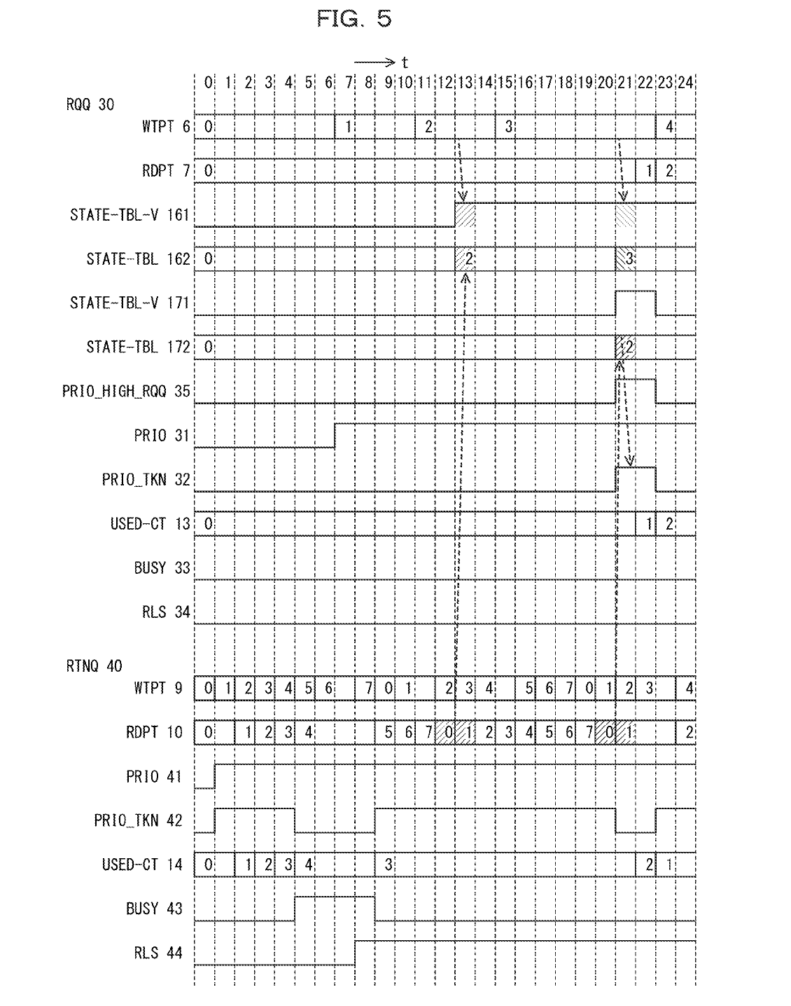

A time chart for that series of operations is depicted in FIG. 5.

FIG. 5 is a time chart illustrating processing in the system controller 2′ as an example of the second embodiment.

Also in FIG. 5, the horizontal line indicates time (cycle), and FIG. 5 illustrates the status of the signals and values of the counters in each cycle.

The “RQQ” in the upper half of FIG. 5 indicates the status of the signals and values of the counters related to the request queue unit 30.

Here, the STATE_TLB-V161 and the STATE_TLB 162 respectively indicate the values of the VALID field 161 and the request queue write pointer field 162 in FIG. 4. Here, the STATE_TLB-V171 and the STATE_TLB 172 respectively indicate the values of the VALID field 171 and the request queue write pointer field 172 in FIG. 4.

The other signals and counters are identical to those in the time chart depicted in FIG. 3 of the system controller 2 as an example of the first embodiment, and their description are omitted.

In FIG. 5, at Cycles t1 to t7, return packets are sequentially sent to the system controller 2′, and the return queue write pointer 9 (WTPT 9) is incremented.

In response, at Cycle t1, the return queue unit 40 enables the prioritization request signal 41 (RTN PRIO 41) for obtaining right to send a packet from the return queue 11. The priority circuit 12 selects the return queue 11, and enables the selection signal 42 (PRIO_TKN 42).

From Cycle t1 to t4, since the return queue unit 40 obtains the packet sending right, the return queue unit 40 increments the return queue read pointer 10 (RDPT 10) every time a return packet is transmitted. At the same time, the resource used counter 14 (USED-CT 14) that counts the number of used return packet destination resources, is also incremented.

As described above, there are four return packet destination resources. Hence, the value of the resource used counter 14 reaches “4” at Cycle t5, no more return packet can be sent. Accordingly, at Cycle t5, the busy signal 43 (BUSY 43) for the return packet destination resources is enabled.

At Cycle t8, when one return packet destination resource is released, the return packet destination resource release signal 44 (RLS 44) is enabled and the busy signal 43 is disabled. Additionally, at Cycle t8, in response to resource release signal 44 (RLS 44) being enabled, the resource used counter 14 is also decremented.

In the meantime, request packets are intermittently sent while the return packets are sent. Every time a request packet is received, the request queue unit 30′ increments the request queue write pointer 6 (WTPT 6) (refer to Cycles t7, t11, t15, and t23).

The priority circuit 12 does not select these request packets since return packets with a priority higher than that of the request packets are stored in the return queue 11.

At Cycle t12, the return queue read pointer 10 (RDPT 10) is incremented from “0” to “1”. In response, at Cycle t13, the VALID field 161 (the STATE_TLB-V161) is enabled, and the value “2” of the request queue write pointer 6 is set to the request queue write pointer field 162 (the STATE_TLB 162).

Similarly at Cycle t20, the return queue read pointer 10 (RDPT 10) is incremented from “0” to “1”. In response, at Cycle t21, the value of the request queue write pointer field 162 (the STATE_TLB 162) is forwarded to the request queue write pointer field 172 (the STATE_TLB 172). Additionally, the value of the VALID field 161 (the STATE_TLB-V161) is forwarded to the VALID field 172 (the STATE_TLB-V171).

Furthermore, the VALID field 161 (the STATE_TLB-V161) is enabled, and the value “3” of the request queue write pointer 6 is set to the request queue write pointer field 162 (the STATE_TLB 162).

As a result, at Cycle t21, the status VALID field 171 and PRIO_HIGH_RQQ 35 are enabled and the request queue write pointer field 162 is set to “2”. Hence, the priority circuit 12 selects a request packet preferentially to a return packet. Consequently, a request packet is transmitted, and the request queue read pointer 7 (RDPT 7) is incremented.

As described above, similar to the system controller 2 as an example of the first embodiment, the system controller 2′ as an example of the present embodiment can select request packets with an assistance of the priority circuit 12 and transmit them, even when a large volume of return packets are received.

Accordingly, while satisfying the restriction that request packet are not allowed to get ahead of preceding return packets, the request packets that are forced to wait can be selected preferentially. Hence, request processing is interrupted during return processing, which increases the degree of parallel processing, thereby preventing the performance from degrading.

Further, the bit count for an FF employed in a control circuit of the present embodiment is 2log₂N, where N is the number of queue entries. The bit count is 6 or 12 when N is 8 or 64, respectively, and the control circuit can be implemented with a further reduced circuit scale as compared to conventional configurations.

### (3) Miscellaneous

Note that the present disclosure is not restricted to the embodiments described above, and various modifications may be made without departing from the spirit of the present disclosure.

For example, although the information processing apparatus 20 has been described as a multi-processor system in the examples of the embodiments as described above, this is not limiting. For example, the system controller of the present embodiments is applicable to systems of other architectures, such as multi-core single processor systems.

Further, the signal outputs in FIGS. 3 and 5 are merely exemplary, and the priority circuit 12 may set the RQ PRIO 31 to “disabled” and output it when the request queue unit 30 is selected, for example. The values of other signals may be modified where appropriate.

In accordance with the present disclosure, degrading of the performance is prevented in a system controller adapting a technique of transmitting a return packet preferentially to a request packet.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A system controller connected to a plurality of processors, the system controller comprising:
a request store that stores a request from a first processor of the plurality of processors;
a return store that stores a return to a second processor of the plurality of processors, the return corresponding to the request from the first processor; and
a priority unit that outputs the return prior to the request, if a return has been stored in the return store when a request is stored in the request store, and outputs the request prior to the return, if no return has been stored in the return store when the request is stored in the request store.

2. The system controller according to claim 1, wherein
the return store comprises a plurality of entries,
the system controller further comprises a read pointer that points one of the plurality of entries in the return store, and
the priority unit determines that no new request is stored after a request is stored in the request store, by detecting that the read pointer has circled the plurality of entries to point all of the plurality of entries after the request is stored in the request store.

3. The system controller according to claim 1, wherein the system controller further includes a status storage that indicates that the read pointer has circled the plurality of entries to point all of the plurality of entries after the request is stored in the request store.

4. A information processing apparatus comprising:
a plurality of processors; and
a system controller, the system controller comprising:
a request store that stores a request from a first processor of the plurality of processors;
a return store that stores a return to a second processor of the plurality of processors, the return corresponding to the request from the first processor; and
a priority unit that outputs the return prior to the request, if a return has been stored in the return store when a request is stored in the request store, and outputs the request prior to the return, if no return has been stored in the return store when the request is stored in the request store.

5. The information processing apparatus according to claim 4, wherein
the return store comprises a plurality of entries,
the system controller further comprises a read pointer that points one of the plurality of entries in the return store, and
the priority unit determines that no new request is stored after a request is stored in the request store, by detecting that the read pointer has circled the plurality of entries to point all of the plurality of entries after the request is stored in the request store.

6. The information processing apparatus according to claim 4, wherein the system controller further includes a status storage that indicates that the read pointer has circled the plurality of entries to point all of the plurality of entries after the request is stored in the request store.

7. A method of controlling a system controller connected to a plurality of processors, the system controller comprising a request store that stores a request from a first processor of the plurality of processors, and a return store that stores a return to a second processor of the plurality of processors, the return corresponding to the request from the first processor, the method comprising:
outputting, by a priority unit, the return prior to the request, if a return has been stored in the return store when a request is stored in the request store; and
outputting, by the priority unit, the request prior to the return, if no return has been stored in the return store when the request is stored in the request store.

8. The method according to claim 7, wherein
the return store comprises a plurality of entries,
the system controller further comprises a read pointer that points one of the plurality of entries in the return store, and
the priority unit determines that no new request is stored after a request is stored in the request store, by detecting that the read pointer has circled the plurality of entries to point all of the plurality of entries after the request is stored in the request store.

9. The method according to claim 7, wherein the system controller further includes a status storage that indicates that the read pointer has circled the plurality of entries to point all of the plurality of entries after the request is stored in the request store.
